(19) United States
(12) Patent Application Publication
(10) Pub. No.: US 2004/0232850 A1
(43) Pub. Date: Nov. 25, 2004

(54) Energy conservation electrical circuitry for lighting control by occupancy sensors, in building's large spaces

(76) Inventor: Jerrick W. Mitchell, Detroit, MI (US)

Correspondence Address: Jerrick W. Mitchell, 80 E. Hancock, 305, Detroit, MI, 48201, US

(21) Appl. No.: 10/831,583

(22) Filed: Apr. 26, 2004

Related U.S. Application Data
(60) Provisional application No. 60/465,958, filed on Apr. 27, 2003.

(51) Int. Cl. H05B 37/02

(52) U.S. Cl. 315/149; 315/159

(57) ABSTRACT

1. Maximum energy conservation is achieved with “occupancy sensor” lighting control. The circuitry of this invention extends occupancy sensing coverage as required for “large space” light control. Occupancy sensors currently sense up to 2000 square feet. Lighting Control Timer Panels are currently used to control lights in large space within a building.

### CROSS-REFERENCE TO RELATED APPLICATIONS: Not applicable

### FEDERALLY SPONSORED RESEARCH OR DEVELOPMENT: Not applicable

### SEQUENCE LISTING OR PROGRAM: Not applicable

### BACKGROUND OF THE INVENTION-FIELD OF INVENTION

field of endeavor: LIGHTING CONTROL

current technology: occupancy sensors currently sense up to 2000 square feet. Lighting Control Timer Panel are used for light control in building's large spaces.

Invention intent: The circuitry of this invention extends occupancy sensing coverage as required in building's large spaces.

The essence of this invention is the configuration of occupancy sensor's output relays in series, which enables occupancy sensors in plurality to act as “one comprehensive occupancy sensor”.

Several manufactured devices and used within my invention. Patent 5,101,141 “Lighting Control” has a receiver unit, that receives signals from an occupancy sensor to switch on circuits by use of electronic digital switching. Patent 5,808,423 “Light Control Reducing Energy Consumption” controls lighting in response to toggling a power switch. Patent 6,392,368 “Distributed Lighting Control System” is a remote control system. None of the above listed patents have the extended occupancy sensing range. My invention switches lighting circuits on and off, through analog switching, by using an on-delay timer output relay, contactors, power supply, connection modules, and comprehensive occupancy sensor. My invention could be listed under “Lighting Control” and “Energy Conservation”

### BRIEF SUMMARY OF THE INVENTION

Maximum energy conservation is achieved with occupancy sensor lighting control. This invention provides complete occupancy sensor coverage for building's large spaces. Previous technology only covered 2000 square feet.

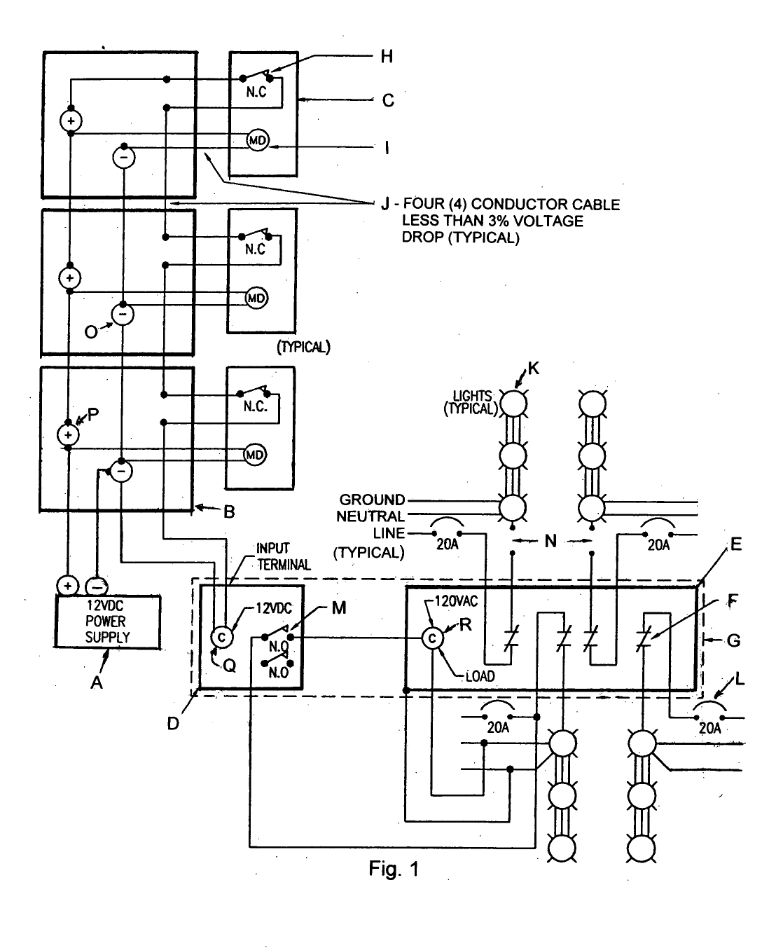

### FIG. 1 DRAWING COMPONENTS

Component (A): Standard 12 VDC power supply rated for 125% of the connected load. For ten (10) 12 VA (watt) load, a 150 VA (watt) power supply should be used.

Component (B): Connection module, prefabricated for easy field wire connection. This module will include a screw set terminal strip. This connection modules shall be fabricated, and labeled for the output relay circuit (H) to be connected in series, to eliminate errors in the field installation process. The connection module (C), and wiring configuration (J) are part of this invention.

Component ( C): A standard dual technology occupancy sensor used in security system applications, rated for 12 VDC. The occupancy sensor's relay (H) shall be normally closed. The output relays (H) open when the detectors (I) sense occupancy.

Component (D) A standard on delay timer relay with a coil (Q) rated for 12 VDC equal to the occupancy sensor (C) 12 VDC rating. The on-delay timer output relay (M) shall be rated for 120 vac, 1 amp, and normally open.

Component (E): A definite purpose dry contactor (F) (normally closed), will open when it's 120 vac coil (R) is energized by the on-delay timer's 120 vac output (M) relay. The “normally closed” contactors (F) are put in series with the lighting circuits. The lighting circuits (L) are considered fail safe, because no energy is required to keep the (F) contactors closed.

Component (F): A dry contactor within (E) is isolated from other circuits and power sources.

Component (G): An enclosure for the definite purpose contactor (E) and on-delay timer relay (D) module.

### DETAIL DESCRIPTION OF THE INVENTION

The large space lighting control system by occupancy sensing is an add on for a regular lighting circuit (L), with wall switches (N). The large space lighting control system has circuitry to automatically open the associated lighting circuits (L). Lighting circuits (L) are open, when the space is totally unoccupied as signaled by occupancy sensing (C).

lighting circuit (L) are connected to one of the dry contactor (F) within the definite purpose contactor (E). The (F) contactors are normally closed, so that the lights (K) can be controlled by a wall toggle switch (N). If the large space lighting control system fails to operate, the lights (K) can still be controlled by the wall toggle switches (N).

Worse case scenario: All the wall toggle switches (N) are left in the on position, within the large space and the space is completely unoccupied; the large space lighting control system's components, will operate as described below.

The power supply (A) provides power to the occupancy sensor (C), for it's sensing operation. The system senses with infrared and ultrasonic detectors (I), connected in series, and both are required to activate, before the occupancy sensor's 12 VDC output relay (H) circuit will open. (the lights (K) are on when any output relay (H) is open, within the series output relay (H) circuit). The 12 VDC output relay (H) circuit is powered by “power supply” (A). The combine operation of infrared and ultrasonic detection (I), is referred to as dual technology, and is a standard device used in electronic security systems.

All of the occupancy sensor's output relays (H) are connected in series. The on-delay timer's coil (Q) is energized, when all of the occupancy sensor output relays (H) are closed, from non occupancy. The on-delay timer's 120 vac output relay (M) closes after the set time delay period.

When the on delay timer's (Q) coil is energized, it's 120 vac output relay (M) circuit closes, and completes a circuit with the definite purpose contactor's (E) 120 vac coil (R), after the set time delay period. The timer re-sets when the (Q) coil is de-energized

When the definite purpose contactor's (R) coil is energized, the normally closed dry contactor (F) (fail safe) opens the light circuits (L). The lights (K) are now off regardless of the wall toggle switches (N) being in the on position.

The lights will continue to be off while the occupancy sensor's output relays (H) are closed from non occupancy. Then someone enters the large room and the lighting circuits (L) are instantly closed to the “lights on” position as described below.

The dual technology sensor (I), detects body heat from the infrared detector, and motion from the ultrasonic detector, then the (H) output relay opens, and causes the dry contactor (F) to close, when coil (R) is not energized, the lights (K) are on.

The lights (K) will stay on until the non occupancy condition described above occurs again, and then the cycle will repeat itself.

1. Energy conservation by “occupancy sensor” lighting control is the most efficient.

2. The circuitry of this invention extends occupancy sensing coverage as required for large spaces within a building. The essence of this invention is the configuration of occupancy sensor's output relays in series, which enables occupancy sensors in plurality to act as “one comprehensive occupancy sensor”. The “one comprehensive occupancy sensor”, controls a timer switch via a lighting contactor. Light circuits are open from non occupancy. This invention includes associated control circuitry, logic, connection modules, wiring and use of manufactured devices as required for a functional lighting control system, as shown on FIG. 1

3. This invention controls lighting circuits, in an existing building or for new construction.
